(19) United States
(12) Patent Application Publication
(10) Pub. No.: US 2016/0165831 A1
(43) Pub. Date: Jun. 16, 2016

(54) LINED WASTE CONTAINER

(71) Applicants: Janet Adams, Pullman, WA (US); Willard Adams, Pullman, WA (US)

(72) Inventors: Janet Adams, Pullman, WA (US); Willard Adams, Pullman, WA (US)

(21) Appl. No.: 14/571,509

(22) Filed: Dec. 16, 2014

(51) Int. Cl. A01K 1/01

(52) U.S. Cl. CPC A01K 1/0125

(57) ABSTRACT

A liner for a litter box comprising a disposable liner positioned within the litter box, where the disposable liner is folded to accommodate an exact size of the litter box, and where the disposable liner includes a top surface; a bottom surface; a set of folded sides surrounding a center portion; and a set of corners, where each corner includes a cut and a fold, where the cut allows the folded side to stand erect while the fold tucks the corner behind the proximal folded edge. The liner further includes a fastener to secure the liner within the litter box.

### BACKGROUND OF THE INVENTION

1. Field of the Invention

The present invention relates to a litter box with a fitted liner to protect the inner surface of the litter box.

2. Description of Related Art

Owning a pet provides a loving and lasting relationship between the animal and their owner. Along with the love is the responsibility of cleaning the animal's untidiness and waste. Cats and even some trained dogs use litter boxes as their preferred place to deposit their waste. This way the pet is able to remain indoors to relieve themselves, never having to go outdoors.

Conventional litter boxes often become malodorous and bacteria filled after repeated uses. This is aggravating for both the owner and the animal. Many times the animal will attempt to eliminate the smell by removing all the litter and feces on their own causing an even bigger mess for the owner to clean. Some people use liners within the litter boxes to prevent the odors from permeating the box itself. The liners help remove the used cat litter and waste. Therefore it would be beneficial in the art to provide a system that prevents odors from accumulating within a litter box between cleanings.

### SUMMARY OF THE INVENTION

In view of the foregoing disadvantages inherent in the prior art, the general purpose of the present invention is to provide a lined waste container to eliminate odors typically associated with litter boxes, configured to include all of the advantages of the prior art, and to overcome the drawbacks inherent therein.

Accordingly, an object of the present invention is to provide a lined waste container, where the removable liner absorbs smells and is secured within a litter box with a plurality of fasteners.

To achieve the above objects, in an aspect of the present invention, a lined waste container is described comprising a disposable liner positioned within the litter box, where the disposable liner is folded to accommodate an exact size of the litter box, and where the disposable liner includes a top surface; a bottom surface; a set of folded sides surrounding a center portion; and a set of corners, where each corner includes a cut and a fold, where the cut allows the folded side to stand erect while the fold tucks the corner behind the proximal folded edge. The liner further includes a fastener to secure the liner within the litter box.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1(A) depicts a disposable liner in an unfolded position in accordance with an exemplary embodiment of the present invention.

FIG. 1(B) depicts a disposable liner in a folded position in accordance with an exemplary embodiment of the present invention.

FIG. 1(C) depicts a surface of the a disposable liner in accordance with an exemplary embodiment of the present invention

### DETAILED DESCRIPTION OF THE DRAWINGS

The present invention relates to a litter box with a fitted liner to protect the inner surface of the litter box. The present invention provides a disposable liner for a waste container. The disposable liner may be reusable, and easily replaced when needed. The disposable liner includes a glossy side and a matte side, where the user places the glossy side against the litter pan. The matte side is made from an absorbent material to absorb wetness and odor, while the glossy side prevents the odor and wetness from seeping into the waste container. The disposable liner remains in place with an adhesive on the glossy side that anchors the liner against the waste container, thereby ensuring that no odors permeate the litter box.

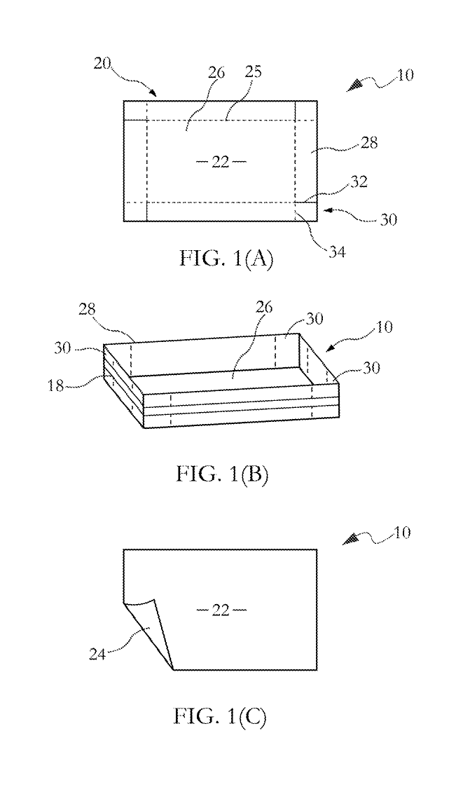

Turning now descriptively to the drawings, referring to FIG. 1(A), a perspective view of a disposable liner 10 is shown in accordance with an exemplary embodiment of the present invention. The disposable liner 10 is positioned within a waste container or litter box. Referring to FIG. 1(A) the disposable liner 10 is illustrated in an unfolded position. The disposable liner 10 includes a center portion 26 surrounded by a set of edges 28. The edges 28 are folded along the lines 25, so that the center portion 26 and the edges 28 perfectly fit into the litter box. At each corner 30 of the liner 10 may be a cut 32 in the material to accommodate fitting the liner 10 into the litter box. The cut 32 allows the edge 25 to stand erect and the remainder of the corner 30 folds along dotted line 34 to fit behind the proximal edge 28. The corners 30 may be held in place with a fastener to ensure that the disposable liner 10 does not unfold during use.

Referring now to FIG. 1(B), the disposable liner 10 is illustrated in a folded position. The center portion 26 is surrounded by the edges 28 in an upright position. The disposable liner 10 mimics the shape of the litter box to ensure that the fit is flush to prevent odor and wetness from leaking. The litter box may be made from plastic, aluminum or other non-porous, washable material to prevent odor and bacteria from seeping into the pores. The size of the disposable liner 10 may vary to accommodate litter boxes of various sizes. The disposable liner 10 covers the interior surface of the litter box, and may be secured in place with one or more fasteners 18. The fasteners 18 may be adhesive strips or two-way tape which are replaced after each cleaning. The two-way tape allows the user to secure the folded corners 30 against the edges 28, while also anchoring the disposable liner 10 within the litter box. The fasteners 18 may completely circumnavigate the disposable liner 10 when in the folded position to maintain the structural integrity of the folded liner 10, to ensure that all of the corners 30 remain folded against the edges 28, and to secure the disposable liner 10 within the litter box.

The disposable liner 10 includes a top surface 22 and a bottom surface 24 illustrated in FIG. 1(C). The disposable liner 10 may be made from a coated paper material. The top surface 22 may be paper or other porous, odor eliminating material to absorb wetness and odor within the cat litter. The bottom surface 24 may be coated with a wax layer to ensure that the wetness and odor does not pass through the liner 10 while the odor is trapped under the wax layer. The bottom surface 24 may be glossy covered with a non-stick, waxy material to ensure easy lifting out of the litter box 12 while still allowing the disposable liner 10 to cling to the litter box. Wetness and odor from the litter will be absorbed by the disposable liner 10 therefore allowing the litter box to remain fresh and unsoiled even after multiple uses. The disposable liners 10 may be biodegradable to ensure that the entire system is environmentally friendly and economically supportive.

The disposable liner 10 is a simple solution to the problem of cleaning dirty litter boxes. The liner 10 allows the user to eliminate the bad odors commonly associated with litter boxes. The liner 10 is disposable allowing the moisture and odor to absorb into the liner material itself. The disposable liner is ideal for those wishing to keep their pet areas clean and fresh.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A disposable liner for a litter box comprising:
a. a top surface;
b. a bottom surface;
c. a center portion, wherein the center portion has four sides;
d. a folding configuration on each side of the center portion; and
e. four corners surrounding the center portion, where each corner includes a cut and a fold, where the cut enables the folded configuration to stand erect while the fold tucks the corner behind the proximal folded edge; and
f. a fastener to secure the liner within the litter box.

2. The disposable liner for a litter box according to claim 1, where a fastener secures each corner behind the proximal folded edge.

3. The disposable liner for a litter box according to claim 2, where the fastener completely circumnavigates the folded disposable liner to ensure that all of the corners remain folded against the edges.

4. The disposable liner for a litter box according to claim 1, where the fastener is a plurality of adhesive strips.

5. The disposable liner for a litter box according to claim 1, where the fastener is two-way tape.

6. The disposable liner for a litter box according to claim 1, where the top surface of the liner is made from a biodegradable paper, and where the bottom surface includes a thin wax layer.
